(19) United States
(12) Patent Application Publication
(10) Pub. No.: US 2010/0057427 A1
(43) Pub. Date: Mar. 4, 2010

(54) SIMULATED PROCESSOR EXECUTION USING BRANCH OVERRIDE

(76) Inventor: Anthony Dean Walker, Rougemont, NC (US)

Correspondence Address: ERICSSON INC., 6300 LEGACY DRIVE, M/S EVR 1-C-11, PLANO, TX, 75024, US

(21) Appl. No.: 12/204,047

(22) Filed: Sep. 4, 2008

(51) Int. Cl. G06F 9/38; G06F 9/00; G06F 12/08

(52) U.S. Cl. 703/17; 712/234; 711/125; 711/E12.017; 712/E09.045

(57) ABSTRACT

A processor simulation environment includes a processor execution model operative to simulate the execution of processor instructions according to the characteristics of a target processor, and branch override logic. When the processor execution model decodes a branch instruction, it requests a branch directive from the branch override logic. In response to the request, the branch override logic provides a branch directive that resolves the branch evaluation. The request may include a branch instruction address. The branch override logic may index an execution trace of instructions executed on a processor compatible with the target processor, using the branch instruction address. The branch directive may include an override branch target address, which may be obtained from the instruction trace, or otherwise calculated by the branch override logic. In this manner, accurate program execution order may be simulated in a simulation environment in which complex I/O is not modeled.

### FIELD OF THE INVENTION

The present invention relates generally to processor simulation, and in particular to a simulation methodology of resolving branch instructions by branch override logic.

### BACKGROUND

Simulation of processor designs is well known in the art. Indeed, extensive simulation is essential to the process of new processor design. Simulation involves modeling a target processor by quantifying the characteristics of its component functional units and relating those characteristics to one another such that the emergent model (that is, the sum of the related characteristics) provides a close representation of the actual processor behavior.

One known method of simulation provides hardware-accurate models of system components, such as Hardware Description Language (HDL) constructs, or their gate-level realizations following synthesis, and simulates actual device states and signals passing between the components. These simulations, while highly accurate, are relatively slow, computationally demanding, and can only occur well into the design process when hardware-accurate models have been developed. Accordingly, they are ill-suited for early simulations useful in illuminating architectural tradeoffs, benchmarking basic performance, and the like.

A more efficient method of simulation provides higher-level, cycle-accurate models of hardware functional units, and models their interaction via a transaction-oriented messaging system. The messaging system simulates real-time execution by dividing each clock cycle into an “update” phase and a “communicate” phase. Cycle-accurate unit functionality is simulated in the appropriate update phases in order to simulate actual functional unit behavior. Inter-component signaling is allocated to communicate phases in order to achieve cycle-accurate system execution. The accuracy of the simulation depends on the degree to which the functional unit models accurately reflect the actual unit functionality and accurately stage inter-component signaling. Highly accurate functional unit models—even of complex systems such as processors—are known in the art, and yield simulations that match real-world hardware results with high accuracy in many applications.

Functional unit accuracy, however, is only part of the challenge of obtaining high fidelity simulations of complex systems such as processors. Meaningful simulations additionally require accurately modeling activity on the processor, such as instruction execution order. In many applications, processor activity may be accurately modeled by simply executing relevant programs on the processor model. However, this is not always possible, particularly when modeling real-time processor systems. For example, the input/output behavior (I/O) may be a critical area to explore, but the actual I/O environment is sufficiently complex to render the development of an accurate I/O model impossible or impractical. This is the situation with respect to many communication-oriented systems, such as mobile communication devices.

One critical aspect of processor simulation accuracy is instruction execution order. All real-world programs include conditional branch instructions, the evaluation of which is not known until run-time. Indeed, in many cases, branch evaluation does not occur until the instruction is evaluated in an execute stage deep in the processor pipeline. To prevent pipeline stalls—that is, halting execution until the branch condition is evaluated—modern processors employ sophisticated branch prediction techniques. The evaluation of conditional branch instructions is predicted when the instructions are decoded, based on past branch behavior and/or other metrics, and instruction fetching continues based on the prediction. That is, if the branch is predicted taken, instructions are fetched from a branch target address (which may be known a priori or may be dynamically calculated). If the branch is predicted not taken, instruction fetching proceeds sequentially (at the address following the branch instruction address). An incorrectly predicted branch can require a pipeline flush to clear the pipe of the incorrectly fetched instructions, as well as a stall while the correct instructions are fetched, adversely impacting both execution speed and power consumption. Accurate branch prediction is thus a major aspect of processor performance, and hence an area of keen interest in processor simulation. However, the I/O environment that determines the resolution of many branch conditions may be too complex to accurately model in a simulation.

### SUMMARY

A processor simulation environment includes a processor execution model operative to simulate the execution of processor instructions according to the characteristics of a target processor, and branch override logic. When the processor execution model decodes a branch instruction, it requests a branch directive from the branch override logic. In response to the request, the branch override logic provides a branch directive that resolves the branch evaluation. The request and branch directive may take a variety of forms. In one embodiment, the request includes the address of the branch instruction being simulated, and optionally a predicted branch target address. The branch override logic may index an execution trace of instructions executed on a processor compatible with the target processor, using the branch instruction address. The branch directive may include an override branch target address, which may be obtained from the instruction trace, or otherwise calculated by the branch override logic. In this manner, accurate program execution order may be simulated in a simulation environment in which complex I/O is not modeled.

### BRIEF DESCRIPTION OF THE DRAWINGS

FIG. 1 is a functional block diagram of a processor simulation environment.

FIG. 2 is a flow diagram of a method of simulating processor execution.

### DETAILED DESCRIPTION

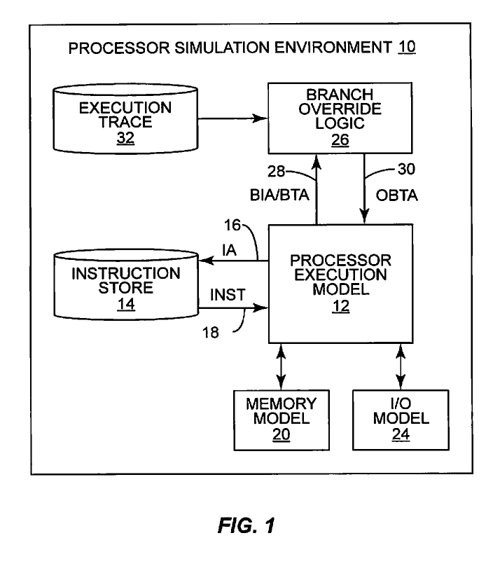

FIG. 1 depicts a processor simulation environment 10 including a processor execution model 12. The processor execution model 12 simulates the execution of instructions according to the characteristics of a target processor. The target processor may be an existing processor or, more likely, a new processor under development. The processor execution model 12 may comprise hardware-accurate models of one or more functional units within the target processor, such as the instruction unit (IU), floating point unit (FPU), memory management unit (MMU), or the like. Alternatively, or additionally, one or more functional units may be modeled by a cycle-accurate functional model, with zero-simulation-time data and/or parameter passing between the functional unit models. In general, the processor execution model 12 may include any processor simulation model known in the art.

The processor execution model 12 simulates operation of a target processor by executing instructions retrieved from an instruction store 14. The instruction store 14 may itself comprise a simulation model of a memory function, such as an instruction cache (I-cache). Alternatively, the instruction store 14 may simply comprise a sequential listing of instructions, such as in an object model produced by a compiler/linker, which could be loaded into memory and executed by the target processor. In one embodiment, the processor execution model 12 fetches one or more instructions from the instruction store 14 by providing an instruction address (IA) 16. In turn, the instruction store 14 provides one or more corresponding instructions 18 to the processor execution model 12.

In various embodiments, the processor simulation environment 10 may additionally include simulation models of memory 20, input/output functions (I/O) 24, and the like, as required or desired. For example, the memory model 20 may be implemented as one or more caches. The I/O model 24 may emulate a UART, parallel port, USB interface, or other I/O function. The processor simulation environment 10 may additionally include other simulation models, or models of an interface to another circuit, such as a graphic processor, cryptographic engine, data compression engine, or the like (not shown).

In some cases, the processor simulation environment 10 cannot provide a sophisticated enough I/O model to ensure meaningful simulation of the processor execution model 12. For example, the target processor may be deployed in a wireless communication system mobile terminal. The complex, dynamic interaction of the mobile terminal (and its processor) with the wireless communication system cannot be accurately simulated. However, performance of the target processor when deployed in the mobile terminal is critical, and developers must be able to simulate many aspects of its operation in that environment.

In particular, one aspect of the target processor's operation that directly and profoundly impacts its performance is the program execution path—that is, the dynamic resolution of branch instructions. According to one or more embodiments of the present invention, known or desired branch instruction behavior is imposed on the processor execution model 12 by branch override logic 26. The branch override logic 26 receives a request 28 for a branch directive from the processor execution model 12 when the latter encounters a conditional branch instruction. In response, the branch override logic 26 provides a branch directive 30, indicating to the processor execution model 12 the resolution of the branch evaluation (i.e., taken or not taken).

The branch override logic 26 may derive the branch directive 30 in several ways. For example, it may examine instructions actually executed on a different processor (such as a prior version of the target processor) under I/O conditions of interest (such as while engaged in wireless communications), stored in an execution trace 32. Alternatively, the branch override logic 26 may compute the branch directive 30 according to various algorithms, such as random, a predetermined probability distribution of taken to not taken branch evaluations based on analysis of the code and knowledge of the environment, by dynamic analysis of the program and the I/O environment, or other approaches. In this manner, meaningful simulation and analysis of the processor execution model 12 is possible, even where the targeted I/O environment cannot be accurately simulated.

The branch directive request 28 from the processor execution model 12, and the branch directive 30 from the branch override logic 26, may take a variety of forms. For example, in one embodiment appropriate for a probabilistic test, the processor execution model 12 may simply assert a signal as a request 28, and receive a single bit as a branch directive 30—e.g., 1=taken and 0=not taken. In this case, the branch override logic 26 controls the branch resolution of branch instructions according to some probability distribution, without regard to each individual instruction or its function within the code being executed.

In another embodiment, the branch directive request 28 from the processor execution model 12 may take the form of the branch instruction address (BIA)—that is, the address of the branch instruction for which execution is being simulated. In this embodiment, the branch override logic 26 may index an execution trace 32 using the BIA (and optionally an offset), to discover the actual branch resolution of a corresponding branch instruction as previously executed. In this embodiment, the branch directive 30 from the branch override logic 26 may take the form of an override branch target address (OBTA)—that is, the address from which the processor execution model 12 should begin executing new instructions.

In still another embodiment, particularly suited for simulating branch prediction logic within the processor execution model 12, the branch directive request 28 from the processor execution model 12 may include both the BIA and a predicted branch target address (BTA). In this embodiment, the branch directive 30 from the branch override logic 26 may comprise a single bit indicative of the accuracy of the branch prediction—e.g., 1=correctly predicted and 0=incorrectly predicted. The branch override logic 26 may compute the accuracy of a branch prediction, or may ascertain it by comparison to the actual branch resolution of a corresponding branch instruction in the execution trace 32, using the BIA. Alternatively, the branch override logic 26 may provide a branch directive 30 in the form of an OBTA. The OBTA will either be the appropriately incremented BIA for a not-taken branch directive 30, or a BTA for a taken branch directive 30. Note that the BTA need not match a predicted-taken BTA as calculated by the processor execution model 12—for example, the branch override logic 26 could force an interrupt or other change in the program execution path by providing an appropriate OBTA.

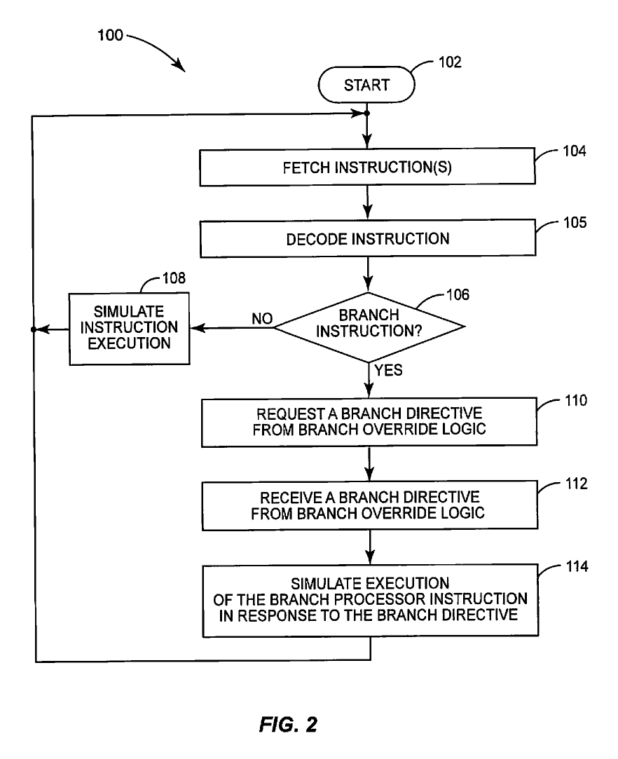

FIG. 2 depicts a method 100 of simulating processor execution. Starting at block 102, the method begins by fetching one or more instructions (block 104). As known in the art, the processor execution model 12 may fetch instructions sequentially, or it may fetch instructions in a group, such as an I-cache line. For each fetched instruction, the processor execution model 12 decodes the instruction (block 105). If the instruction is not a branch instruction (block 106), the processor execution model 12 simulates execution of the instruction (block 108), such as by loading the instruction into a model of an execution pipeline. When the processor execution model 12 decodes a branch instruction (block 106), it issues to the branch override logic 26 a request 28 for a branch directive (block 110). The processor execution model 12 then receives a branch directive 30 from the branch override logic 26 (block 112). The processor execution model 12 then simulates execution of the branch instruction, by fetching and executing instructions at an address determined by the branch directive 30 (block 114).

The request 28 and branch directive 30 may comprise simulated electrical signals, where the processor execution model 12 (or at least a model of an interface thereof) comprises a hardware-accurate simulation model, such as a hardware description language (HDL) model, a gate-level model functional model, or the like. Alternatively, where the processor execution model 12 comprises a cycle-accurate functional model, the request 28 and branch directive 30 may comprise zero-simulation-time messages passed between the processor execution model 12 and branch override logic 26, according to a transaction-oriented messaging system defined for the processor simulation environment 10. Those of skill in the art may readily implement appropriate request 28 and branch directive 30 signaling for any particular simulation environment.

Providing branch directives 30 by branch override logic 26 allows the processor simulation environment 10 to simulate the processor execution model 12 with minimal I/O modeling or emulation. The processor execution model 12 may simulate instructions as a target processor would, with intervention only at the point of branch determination. This is particularly important when a high degree of simulation accuracy is desired. Additionally, by separating the branch override logic 26 from the processor execution model 12, a variety of branch override schemes may be implemented, as desired or required for a particular simulation.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of simulating processor execution, comprising:
decoding a processor instruction to determine whether the instruction is a branch instruction; and
simulating the execution of a branch instruction by
requesting a branch directive from branch override logic;
receiving a branch directive from branch override logic in response to the request; and
simulating execution of the branch instruction according to the branch directive from the branch override logic.

2. The method of claim 1 wherein requesting a branch directive from branch override logic comprises providing the branch instruction address to the override logic.

3. The method of claim 2 wherein requesting a branch directive from branch override logic further comprises providing a branch target address to the override logic.

4. The method of claim 1 wherein the branch directive received from branch override logic comprises an override branch target address.

5. The method of claim 5 wherein simulating execution of the branch processor instruction in response to the branch directive from the branch override logic comprises simulating the executing of one or more instructions beginning at the override branch target address.

6. The method of claim 1 wherein the branch directive received from branch override logic comprises a bit.

7. A processor simulation environment, comprising:
a processor execution model operative to simulate the execution of processor instructions according to characteristics of a target processor, and further operative to request a branch directive upon decoding a branch instruction, receive a branch directive in response to the request, and simulate execution of the branch instruction according to the branch directive; and
branch override logic operative to receive a branch directive request from the processor execution model and provide a branch directive in response to the request.

8. The processor simulation environment of claim 7 further comprising an instruction execution trace accessible by the branch override logic, the instruction execution trace comprising instructions previously executed by a processor compatible with the target processor.

9. The processor simulation environment of claim 7 further comprising an instruction store from which the processor execution model fetches instructions.

10. The processor simulation environment of claim 7 wherein the instruction store models an instruction cache.

11. The processor simulation environment of claim 7 wherein the branch directive request comprises the address of the branch instruction being simulated.

12. The processor simulation environment of claim 11 wherein the branch directive request further comprises a branch target address.

13. The processor simulation environment of claim 7 wherein the branch directive comprises an override branch target address.

14. The processor simulation environment of claim 13 wherein the processor execution model is operative to simulate execution of the branch instruction according to the branch directive by simulating the executing of one or more instructions beginning at the override branch target address.

15. The processor simulation environment of claim 7 wherein the branch directive comprises a bit.

16. A processor execution model comprising functional unit models collectively operative to simulate the execution of processor instructions according to characteristics of a target processor, and further operative to
request a branch directive upon decoding a branch instruction,
receive a branch directive in response to the request, and
simulate execution of the branch instruction according to the branch directive.

17. The processor execution model of claim 16 wherein the branch directive comprises an override branch target address, and wherein the functional unit models are collectively operative to simulate execution of the branch instruction according to the branch directive by simulating the executing of one or more instructions beginning at the override branch target address.
